(19) United States
(12) Patent Application Publication
(10) Pub. No.: US 2014/0035284 A1
(43) Pub. Date: Feb. 6, 2014

(54) WIND PARK CONTROL SYSTEM

(71) Applicant: John Bech, Hammel (DK)

(72) Inventor: John Bech, Hammel (DK)

(21) Appl. No.: 13/951,705

(22) Filed: Jul. 26, 2013

(30) Foreign Application Priority Data
Jul. 31, 2012 (EP) 12178689.1

(51) Int. Cl. F03D 9/00

(52) U.S. Cl. CPC F03D 9/005
USPC 290/44

(57) ABSTRACT

A wind park control system for controlling reactive power output of wind turbines is described. The wind park delivers active power and reactive power to a utility grid. A total amount of reactive power required by the utility grid and an individual amount of reactive power for each wind turbine are determined. A capability scheme having an order for selecting the wind turbines to deliver reactive power is calculated based on the individual amount of reactive power and the total electrical power loss contributed by each connection of the wind turbines to the utility grid. An actual amount of reactive power provided by the wind turbines is adjusted. The reactive power output of each wind turbine is controlled based on the capability scheme. The wind turbines are selected for delivering reactive power in the order of the capability scheme so that the total amount of reactive power is fulfilled.

### CROSS REFERENCE TO RELATED APPLICATIONS

The present application claims priority to European Patent Office application No. 12178689.1 EP filed Jul. 31, 2012, the entire content of which is hereby incorporated herein by reference.

### FIELD OF INVENTION

The present invention relates to the technical field of wind parks. In particular, the present invention relates to a control system for a wind park, in particular controlling the reactive power output of each wind turbine in the wind park.

### BACKGROUND OF INVENTION

Wind parks comprise a plurality of single wind turbines and provide power to a utility grid. Today utility grids require reactive power delivery/consumption from wind power plants or parks. The reactive power may be needed for instance by loads (like electrical motors). Modern wind turbines may be able to control their reactive power output. Thus, the reactive power requirement of the utility grid may be fulfilled.

Typically, all wind turbines deliver or consume reactive power based on the same reference. Thereby, all wind turbines contribute with almost the same amount of reactive power. All wind turbines provide electrical loss to the overall system, however, some wind turbines give more electrical loss than other.

### SUMMARY OF INVENTION

Therefore, there may be a need for an efficient and reliable control of the reactive power of the wind park to ensure that overall requirements are fulfilled and electrical losses are minimized.

This need may be met by the subject matter according to the independent claims. Advantageous embodiments of the present invention are described by the dependent claims.

According to a first aspect of the invention, there is provided a wind park control system for controlling a reactive power output of a plurality of wind turbines of a wind park, wherein the wind park is adapted to deliver active power and reactive power to a utility grid. The wind park control system comprises a determination unit being adapted to determine a total amount of reactive power being required by the utility grid (which corresponds to receiving information from the utility grid being indicative for the total amount of reactive power being required by the utility grid) and being adapted to determine for each wind turbine an individual amount of reactive power, which the wind turbine is capable to deliver, a calculation unit being adapted to calculate a capability scheme, wherein the capability scheme comprises an order for the plurality of wind turbines according to which order the wind turbines are selected for delivering reactive power, wherein the capability scheme is calculated based on the determined individual amount of reactive power of each wind turbine and the total electrical power loss being contributed by each connection of all the wind turbines to the utility grid, and an adjustment unit being adapted to adjust an actual amount of reactive power to be provided by the plurality of wind turbines, wherein the reactive power output of each wind turbine is controlled based on the calculated capability scheme wherein the wind turbines are selected for delivering reactive power in the order of the capability scheme, such that the determined total amount of reactive power is fulfilled.

A wind park may comprise a plurality of wind turbines for delivering power to a utility grid. A wind turbine may be used for generating electrical power by converting wind into electrical power. Typically, wind turbines comprise a tower, a wind turbine rotor, which is arranged at a top portion of the tower and which comprises at least one blade, and a generator being mechanically coupled with the wind turbine rotor.

Based on an input power, the wind, the generator is able to convert the input power into electrical output power. The utility grid, to which power may be delivered, may have some requirements, in particular reactive power requirements, which should be fulfilled. These requirements may be provided to the wind park control system, in particular the determination unit. The utility grid may have specific requirements for the reactive power. The requirements for delivery/consumption of reactive power from the wind park or wind power plant may be either reactive power, power factor or voltage control.

To reduce the electrical losses, which may occur caused by the connection between a wind turbine and the connection point of the wind park and the utility grid, wind turbines contributing less electrical loss may be preferred for providing or delivering reactive power. The wind turbines may be selected according to the electrical loss they contribute and according to the amount of reactive power they may provide. The wind turbines may be selected in a number or amount sufficient for fulfilling the requirements for reactive power of the utility grid. Thus, the reactive power of the wind turbines may be accumulated.

The determination unit and the calculation unit may be integrated as one single unit. The plurality of wind turbines may be at least two wind turbines.

According to an embodiment of the invention, the determination unit is adapted to determine the individual amount of reactive power for each wind turbine based on a generated active power and a voltage at the wind turbine.

According to this embodiment, the reactive power each wind turbines is capable to deliver may be determined first. The determination may be based on an actual voltage and an actual active power generated at the wind turbine.

According to a further embodiment of the invention, the order of the wind turbines in the capability scheme is based on priorities, wherein a wind turbine having a connection with the lowest electrical loss has the highest priority. Thus, the wind turbine having the minimum electrical collector network power loss from all the wind turbines may have the highest priority.

The capability scheme may comprise a table wherein the wind turbines are arranged in an order corresponding to the amount of electrical loss they are providing. Hereby, the wind turbine contributing the lowest electrical loss may have the highest priority, wherein a wind turbine contributing more electrical loss may have a lower priority.

According to a further embodiment of the invention, the determination unit is adapted to determine the electrical losses based on a resistance being provided by the connection and a current being associated with the reactive power of the wind turbine.

The electrical loss each wind turbine is contributing may be determined based on characteristics of the connection. Each connection may have a specific resistance. The electrical loss may be calculated by the resistance of the connection multiplied with a current squared, wherein the current may consist of two parts, active current and reactive current. The current may be associated with the reactive power of the wind turbine.

According to a further embodiment of the invention, the order of the wind turbines in the capability scheme is based on priorities, wherein a priority is associated with the resistance being provided by the corresponding connection such that a low resistance is associated with a high priority.

The capability scheme may comprise a table wherein the wind turbines are arranged in an order corresponding to the amount of resistance of the corresponding connection. Hereby, the wind turbine having the connection with the lowest resistance may have the highest priority, wherein a wind turbine having a connection with a higher resistance may have a lower priority.

According to a further embodiment of the invention, the determination unit is further adapted to determine for each wind turbine an individual amount of reactive power, which the wind turbine is capable to consume, and the calculation unit is adapted to calculate the capability scheme based on the determined individual amount of reactive power of each wind turbine, which each wind turbine is capable to deliver and/or consume.

In addition to the capability of delivering reactive power, the determination unit may also determine the capability of each wind turbine to consume reactive power. The capability scheme may in this case comprise information about the capability of delivering and consuming reactive power for each wind turbine.

According to a further embodiment of the invention, the adjustment unit is further adapted to adjust the actual amount of reactive power to be provided by the plurality of wind turbines by controlling the reactive power output of each wind turbine based on the calculated capability scheme such that the wind turbines are selected for delivering and/or consuming reactive power to fulfill the determined total amount of reactive power.

In addition to delivering reactive power, each wind turbine may also consume reactive power. This may be used for adjusting the reactive power being needed by the utility grid.

According to a further aspect of the invention, a wind park is provided. The wind park comprises a wind park control system having the above mentioned features and a plurality of wind turbines being controllable by the wind park control system.

The wind park control system may be located near the wind turbines or may be located remote. Further, the wind park control system may be comprised by single units, each unit being located near a wind turbine.

According to a further aspect of the invention, a method for controlling a reactive power output of a plurality of wind turbines of a wind park is provided, wherein the wind park is adapted to deliver active power and reactive power to a utility grid. The method comprises determining, by a determination unit, a total amount of reactive power being required by the utility grid and determining for each wind turbine an individual amount of reactive power, which the wind turbine is capable to deliver, calculating, by a calculation unit, a capability scheme, wherein the capability scheme comprises an order for the plurality of wind turbines, according to which order the wind turbines are selected for delivering reactive power, wherein the capability scheme is calculated based on the determined individual amount of reactive power of each wind turbine and the total electrical power loss being contributed by each connection of all the wind turbine to the utility grid, and adjusting, by an adjustment unit, an actual amount of reactive power to be provided by the plurality of wind turbines, wherein the reactive power output of each wind turbine is controlled based on the calculated capability scheme wherein the wind turbines are selected for delivering reactive power in the order of the capability scheme, such that the determined total amount of reactive power is fulfilled.

According to a further aspect of the invention, there is provided a computer program for controlling a reactive power output of a plurality of wind turbines of a wind park, the computer program, when being executed by a data processor, is adapted for controlling the method as described above.

According to a further aspect of the invention, there is provided a computer-readable medium, in which a computer program for controlling a reactive power output of a plurality of wind turbines of a wind park is stored, which computer program, when being executed by a processor, is adapted to carry out or control a method as described above.

As used herein, reference to a computer program is intended to be equivalent to a reference to a program element and/or a computer readable medium containing instructions for controlling a computer system to coordinate the performance of the above described method.

The computer program may be implemented as computer readable instruction code by use of any suitable programming language, such as, for example, JAVA, C++, and may be stored on a computer-readable medium (removable disk, volatile or non-volatile memory, embedded memory/processor, etc.). The instruction code is operable to program a computer or any other programmable device to carry out the intended functions. The computer program may be available from a network, such as the World Wide Web, from which it may be downloaded.

The herein disclosed subject matter may be realized by means of a computer program respectively software. However, the herein disclosed subject matter may also be realized by means of one or more specific electronic circuits respectively hardware. Furthermore, the herein disclosed subject matter may also be realized in a hybrid form, i.e. in a combination of software modules and hardware modules.

It has to be noted that embodiments of the invention have been described with reference to different subject matters. In particular, some embodiments have been described with reference to apparatus type claims whereas other embodiments have been described with reference to method type claims. However, a person skilled in the art will gather from the above and the following description that, unless other notified, in addition to any combination of features belonging to one type of subject matter also any combination between features relating to different subject matters, in particular between features of the apparatus type claims and features of the method type claims is considered as to be disclosed with this document.

### BRIEF DESCRIPTION OF THE DRAWINGS

The aspects defined above and further aspects of the present invention are apparent from the examples of embodiments to be described hereinafter and are explained with reference to the examples of embodiment. The invention will be described in more detail hereinafter with reference to examples of embodiment but to which the invention is not limited.

FIG. 1 shows a wind park comprising a wind park control system according to an embodiment of the present invention.

FIG. 2 shows a flow diagram for controlling a wind park according to a further embodiment of the invention.

FIG. 3 shows a capability scheme according to an embodiment of the invention.

FIG. 4 shows a wind park layout according to an embodiment of the invention.

### DETAILED DESCRIPTION OF INVENTION

The illustration in the drawing is schematically. It is noted that in different figures, similar or identical elements are provided with the same reference signs.

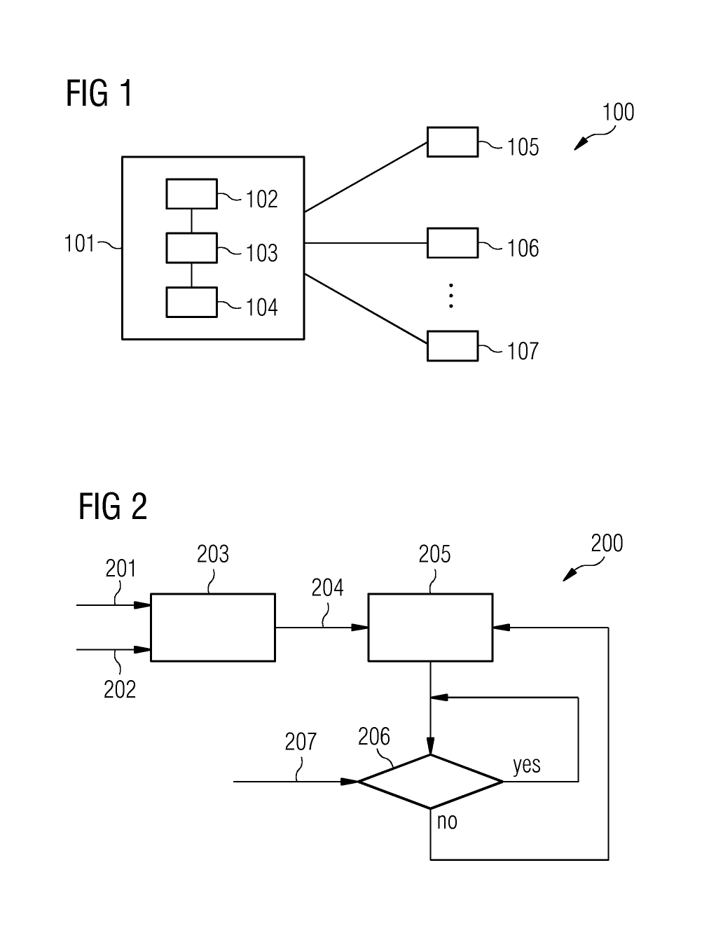

FIG. 1 shows a wind park 100. The wind park 100 comprises a wind park control system 101 and a plurality of wind turbines 105, 106, 107. The wind park control system is adapted to control a reactive power output of the plurality of wind turbines. The wind park may deliver active power and reactive power to a utility grid (not shown).

The wind park control system comprises a determination unit 102, a calculation unit 103 and an adjustment unit 104. The determination unit 102 is adapted to determine a total amount of reactive power being required by the utility grid. The determination unit is further adapted to determine for each wind turbine an individual amount of reactive power, which the wind turbine is capable to deliver.

The calculation unit 103 is adapted to calculate a capability scheme. The capability scheme comprises an order for the plurality of wind turbines according to which the wind turbines are selected for delivering reactive power. The capability scheme is calculated based on the determined individual amount of reactive power of each wind turbine and an electrical loss occurring due to a connection from each wind turbine to the utility grid.

The adjustment unit 104 is adapted to adjust an actual amount of reactive power to be provided by the plurality of wind turbines. The reactive power output of each wind turbine is controlled based on the calculated capability scheme wherein the wind turbines are selected for delivering reactive power in the order of the capability scheme such that the determined total amount of reactive power is fulfilled.

FIG. 2 illustrates a flowchart for the function of the wind park control system. An amount of active power from all wind turbines 201 and an amount of voltage at all wind turbines 202 is provided to the calculation/determination unit 203. In this unit, the capability scheme is calculated and provided 204 to the adjustment unit 205. Here, the reactive power deliver from the wind turbines is adjusted according to the capability scheme. In a next step 206, it is determined whether the reactive power requirements 207 from the utility grid are fulfilled. If yes, it may be repeatedly determined whether the requirements are still fulfilled. If no, the adjustment may be repeated.

To reduce electrical losses in the electrical network of the wind power plant, the capability scheme may be set up so that the wind turbines that give the lowest losses in the network are used first to deliver/consume the reactive power. The capability scheme comprises information so that the turbines being electrical closest to the connection point of the wind farm/park to the utility grid are first used to deliver/consume the reactive power required by the utility grid.

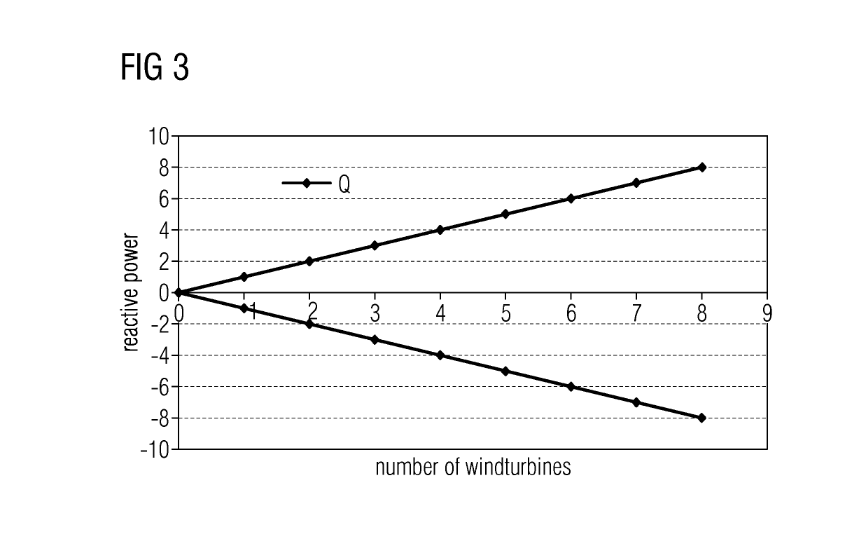

FIG. 3 illustrates an example for a capability scheme according to an embodiment of the invention. The scheme is shown for eight wind turbines. On the x-axis, the numbers represent the wind turbines. On the y-axis, the accumulated reactive power from all wind turbines is shown. The wind turbine 1 is electrical closest to the connection point of the wind farm (i.e., contributes the lowest electrical loss) and then wind turbine 2 is the next and so on up to number 8. The wind turbine numbers are where the wind turbine is at their reactive power capacity. It may be assumed that each wind turbine can deliver/consume +/−1.0 pu (per-unit) reactive power in this example.

For example, if it is required that the wind turbines deliver 4.5 pu reactive power, then wind turbine 1, 2, 3 and 4 have to deliver their full reactive power of 1.0 pu and wind turbine 5 has to deliver 0.5 pu. If there is a change in the reactive power requirement, then the control system should follow the curve to have a jumpless transfer between two reactive power setpoints.

In a real wind farm, the curve of FIG. 3 may be generated from information from the wind turbines about their capability to deliver/consume reactive power. This capability may be typically dependent on active power generated and voltage at the wind turbines. The active power and voltage from each wind turbine may be send to the determination/calculation unit, which then calculates the capabilities for deliver/consume reactive power.

The electrical losses in the wind farm network are related to the resistance time the current squared. The current may consist of two parts, one is active current and the other is reactive current. One idea of the present system is to prioritize the reactive current. This means that the reactive current may run through a minimum if resistance. Further, the control system may follow the line of FIG. 3 to give a jumpless transfer between two reactive power setpoints. Further, the curve of FIG. 3 may be generated from information from the wind turbines about active power generated and voltage. This information may then be used to determine the capability of the wind turbines to deliver/consume reactive power.

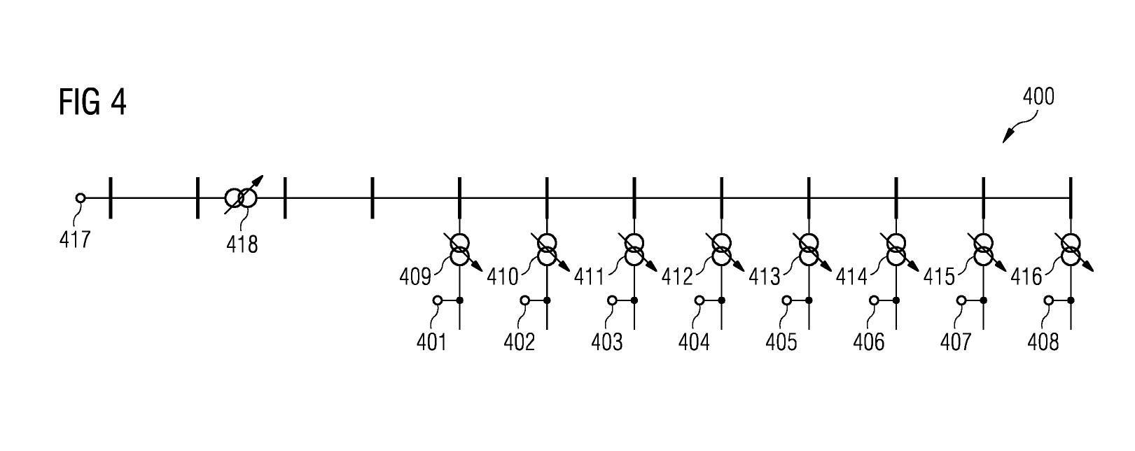

FIG. 4 illustrates a further exemplary embodiment of a wind park 400. Eight wind turbines 401 to 408 are connected via transformers 409 to 416 to a common line, for example a cable. A utility grid 417 is connected to the common line via a transformer 418.

In one case, all eight wind turbines may deliver 0.6 MVAr in a normal operation. In a second case, the four wind turbines electrically closest to the delivery point of the grid (i.e., the wind turbines 401 to 404) deliver 1.0 MVAr. The operation in the second case corresponds to the operation as described herein when using the described capability scheme. In both scenarios, the wind turbines deliver 4.0 MVAr in total.

A Weibull wind distribution with factors 2 and 7 may be used to calculate the yearly losses. When comparing the network losses in the two scenarios, the losses are reduced by 125 MWh when using the operation according to the herein described wind park control system.

It should be noted that the term “comprising” does not exclude other elements or steps and “a” or “an” does not exclude a plurality. Also elements described in association with different embodiments may be combined. It should also be noted that reference signs in the claims should not be construed as limiting the scope of the claims.

1. A wind park control system for controlling a reactive power output of a plurality of wind turbines of a wind park to deliver an active power and a reactive power to a utility grid, comprising:
a determination unit adapted to determine a total amount of reactive power required by the utility grid and to determine an individual amount of reactive power for each wind turbine being capable to deliver;
a calculation unit adapted to calculate a capability scheme for selecting the wind turbines according to an order to deliver the reactive power, wherein the capability scheme is calculated based on the individual amount of reactive power and a total electrical power loss contributed by connections of the wind turbines to the utility grid; and
an adjustment unit adapted to adjust an actual amount of reactive power provided by the wind turbines,
wherein a reactive power output of each wind turbine is controlled based on the capability scheme, and
wherein the wind turbines are selected based on the order of the capability scheme to fulfill the total amount of reactive power.

2. The wind park control system according to claim 1, wherein the determination unit is adapted to determine the individual amount of reactive power for each wind turbine based on a generated active power and a voltage at the each wind turbine.

3. The wind park control system according to claim 1, wherein the order in the capability scheme for selecting the wind turbines is based on priorities, and wherein a wind turbine having a connection with a lowest electrical loss has a highest priority.

4. The wind park control system according to claim 1, wherein the determination unit is adapted to determine an individual electrical power loss based on a resistance provided by connection of each wind turbine and a current associated with the reactive power of each wind turbine.

5. The wind park control system according to claim 4, wherein the order in the capability scheme for selecting the wind turbines is based on priorities, wherein a priority is associated with the resistance provided by the connection so that a low resistance is associated with a high priority.

6. The wind park control system according to claim 1,
wherein the determination unit is adapted to determine an individual amount of reactive power for each wind turbine being capable to consume, and
wherein the calculation unit is adapted to calculate the capability scheme based on the individual amount of reactive power of each wind turbine being capable to deliver and/or consume.

7. The wind park control system according to claim 1, wherein the adjustment unit is adapted to adjust the actual amount of reactive power provided by the wind turbines by controlling the reactive power output of each wind turbine based on the capability scheme so that the wind turbines are selected for delivering and/or consuming reactive power to fulfill the total amount of reactive power.

8. A method for controlling a reactive power output of a plurality of wind turbines of a wind park to deliver an active power and a reactive power to a utility grid, comprising:
determining a total amount of reactive power required by the utility grid and determining an individual amount of reactive power for each wind turbine being cable to deliver by a determination unit;
calculating a capability scheme by a calculation unit for selecting the wind turbines according to an order to deliver the reactive power, wherein the capability scheme is calculated based on the individual amount of reactive power and a total electrical power loss contributed by connections of the wind turbines to the utility grid; and
adjusting an actual amount of reactive power provided by the wind turbines by an adjustment unit;
controlling a reactive power output of each wind turbine based on the capability scheme; and
selecting the wind turbines based on the order in the capability scheme to fulfill the total amount of reactive power.

9. A computer-readable medium, comprising:
a computer program stored in the computer-readable medium for controlling a reactive power output of a plurality of wind turbines of a wind park to deliver an active power and a reactive power to a utility grid,
wherein the computer program is executed by a processor to perform a method as claimed in claim 8.
